(19) United States
(12) Patent Application Publication
(10) Pub. No.: US 2021/0388892 A1
(43) Pub. Date: Dec. 16, 2021

(54) DIFFERENTIAL DEVICE

(71) Applicant: MUSASHI SEIMITSU INDUSTRY CO., LTD., TOYOHASHI-SHI, AICHI (JP)

(72) Inventor: Hirohisa ODA, TOYOHASHI-SHI, AICHI (JP)

(21) Appl. No.: 17/424,724

(22) PCT Filed: Jan. 22, 2020
(86) PCT No.: PCT/JP2020/002041

§ 371 Date: Jul. 21, 2021

(30) Foreign Application Priority Data
Mar. 26, 2019 (JP) 2019-058619

(51) Int. Cl. F16H 48/40; F16H 48/08

(52) U.S. Cl. CPC F16H 48/40; F16H 48/08; F16H 2048/085; F16H 2048/405; F16H 2048/087

(57) ABSTRACT

In a differential device, a differential casing is formed of lightweight alloy, and gears are formed of steel. A plurality of screw hole bosses each including a screw hole to which each of a plurality of bolts is fastened to fasten a ring gear, and a first rib integrally coupling the screw hole bosses together are protrudingly provided at the side face of a flange. A plurality of second ribs integrally coupling the screw hole bosses and a first bearing boss together is provided on the external side face of a differential casing. A first thickened portion including a first gear support portion that supports the back surface of a pinion gear is formed on the circumferential wall of a differential casing body. A second thickened portion that includes a second gear support portion which supports the back surface of a side gear is formed on the first bearing boss.

### TECHNICAL FIELD

The present disclosure relates to a differential device mainly loaded on a vehicle, in particular, a differential device that includes a ring gear meshed with and driven by a drive gear coupled to an engine, a differential casing that rotates together with the ring gear around a first axial line, and bevel gear-type differential mechanism which is held in the mechanism space of the differential casing, and which distributes and transmits the drive force by the ring gear to first and second drive shafts arranged side by side on the first axial line.

### BACKGROUND ART

Conventionally, as disclosed in Patent Document 1, a differential casing is known which is formed of lightweight alloy, such as an Al alloy or an Mg alloy, and which has a smaller specific weight than that of general steel for the purpose of weight saving of the differential casing.

### CITATION LIST

### Patent Literatures

[Patent Document 1] JP H09-229163 A

### SUMMARY OF INVENTION

### Technical Problem

Meanwhile, if the differential casing is formed of lightweight alloy, since lightweight alloy has a lower rigidity than that of steel, if the differential casing is formed of lightweight alloy, it is a technical problem to cause the differential casing to have a high rigidity that can withstand thrust load caused at a meshed portion between the ring gear and the drive gear when, in particular, the ring gear is driven by the drive gear coupled to an engine. In order to accomplish the high rigidity for the differential casing, if the differential casing is simply thickened, the advantages such that the differential casing is formed of lightweight alloy for the purpose of weigh saving are diminished, and thus it is desired to enhance the rigidity without avoiding an increase in the weight of the differential casing formed of lightweight alloy as much as possible.

Moreover, since lightweight alloy has a higher thermal expansion coefficient than that of steel, in the case of a differential device in which the differential casing is formed of lightweight alloy but the gears of a differential mechanism are formed of steel, there is a disadvantageous possibility such that heat is generated due to the actuation of the differential mechanism, and a backlash between the meshed gears increases due to the difference in thermal expansion between the differential casing and the gears. Hence, it is also a technical problem for enhancing a heat dissipation performance so as to suppress the thermal expansion of the differential casing formed of lightweight alloy as much as possible.

The present disclosure has been made in view off the foregoing circumstances, and an objective is to enhance a rigidity while suppressing an increase in the weight of a differential casing as much as possible and also to enhance a heat dissipation performance in a differential device in which a differential casing is formed of lightweight alloy but the gears of a differential mechanism are formed of steel.

### Solution to Problem

In order to accomplish the above objective, a differential device according to the present disclosure includes:

a ring gear that is meshed with and driven by a drive gear coupled to an engine;

a differential casing which is formed of lightweight alloy and which rotates together with the ring gear around a first axial line; and

a differential mechanism which is held in a mechanism space of the differential casing, and which includes gears for distributing and transferring drive force by the ring gear to first and second drive shafts arranged side by side along the first axial line, the gears being formed of steel.

The differential mechanism includes:

a pinion shaft placed on a second axial line intersecting with the first axial line in the mechanism space at right angles;

a pinion gear which is rotatably supported by the pinion shaft, and which has a back surface supported by a first gear support portion of an inner surface of the mechanism space; and

a side gear which is coupled to the first and second drive shafts while being meshed with the pinion gear, and which has a back surface supported by a second gear support portion of an inner surface of the mechanism space.

The differential casing includes:

a differential casing body that defines the mechanism space;

a flange which is integrally provided with an outer circumferential portion of the differential casing body, and which includes, at one side surface, a gear attachment portion to which the ring gear is fastened by a plurality of bolts arranged side by side in a circumferential direction; and

first and second bearing bosses which are integrally provided at respective sides of the differential casing body, arranged with a transmission casing side by side on the first axial line so as to be rotatably supported, and rotatably support the first and second drive shafts.

A plurality of protruding screw hole bosses each having a screw hole to be fastened with each of the plurality of bolts, and a first rib that integrally joints the plurality of screw hole bosses together are formed in and on an other side face of the flange.

A plurality of second ribs each joining each of the screw hole bosses and the first bearing boss at the other-side-face side together through the flange and through the differential casing body is formed on an external side face of the differential casing.

A first thickened portion which includes the first gear support portion and which is thicker than a portion of a circumferential wall of the differential casing that covers a meshed portion between the pinion gear and the side gear is formed on the circumferential wall.

A second thickened portion which includes the second gear support portion and which is thicker than the portion of the circumferential wall that covers the meshed portion between the pinion gear and the side gear is formed on the first bearing boss.

This is a first feature.

Moreover, according to the present disclosure, in addition to the first feature, the first thickened portion includes a shaft hole boss which is formed in the outer circumferential portion of the differential casing body on the second axial line, and which receives an end of the pinion shaft, and the second ribs are placed at both sides of the second axial line as viewed from a side face of the differential casing. This is a second feature.

Furthermore, according to the present disclosure, in addition to the first or second feature, the first thickened portion is formed by the shaft hole boss, and the flange that is integrally formed with the shaft hole boss so as to include a side wall of the shaft hole boss at a second-rib side, and the ring gear and the pinion shat are coupled to each other so as to transmit torque, and a gap is provided between a shaft hole of the shaft hole boss and the pinion shaft received therein. This is a third feature.

### Advantageous Effects of Invention

According to the first feature, when the ring gear is driven by the drive gear, thrust load acting on the ring gear from the drive gear is transmitted to the screw hole boss from the bolt near a point where such thrust load acts, is transmitted to the plurality of other screw hole bosses through the first rib, and is also transmitted to the plurality of second ribs and the first bearing boss. Hence, those screw hole bosses, the first rib, the second ribs, and the first bearing boss cooperatively support the thrust load, thereby effectively reinforcing the differential casing. Accordingly, a high rigidity that can withstand the thrust load can be given to the differential casing formed of lightweight alloy, in particular, to the differential casing while suppressing an increase in the weight as much as possible, a tilting of the ring gear due to the thrust load can be suppressed. Hence, an appropriate meshed state between the drive gear and the ring gear can be maintained.

Moreover, since the first gear support portion is included in the first thickened portion that has a large thermal capacity in the differential casing body, friction heat generated at the first gear support portion due to the rotation of the pinion gear is absorbed by the first thickened portion, and an excessive temperature rise does not occur at the first thickened portion that has a large thermal capacity. Moreover, the heat absorbed by the first thickened portion is promptly dissipated by the heat dissipation fin function from the second rib and the first rib continuous to the first thickened portion through the differential casing body. Furthermore, since the second gear support portion is included in the second thickened portion that has a large thermal capacity in the first bearing boss, friction heat generated at the second gear support portion due to the rotation of the side gear is absorbed by the second thickened portion, and is promptly dissipated by the heat dissipation fin function from the second rib and the first rib continuous to the first bearing boss. Accordingly, the differential casing formed of lightweight alloy can accomplish an excellent heat dissipation performance, and an expansion of the differential casing by heat generation due to the actuation of the differential mechanism can be suppressed.

According to the second feature of the present disclosure, the first thickened portion includes a shaft hole boss which is formed in the outer circumferential portion of the differential casing body on the second axial line, and which receives an end of the pinion shaft, and the second ribs are placed at both sides of the second axial line as viewed from a side face of the differential casing. Hence, at least the two second ribs are located near the shaft hole boss, making heat transfer from the shaft hole boss including the first gear support portion to the second rib excellent, thereby further enhancing the heat dissipation performance of the differential casing.

According to the third feature of the present disclosure, the flange and the shaft hole boss are integrated in such a way that the flange includes the one side wall of the shaft hole boss to form the first thickened portion. Hence, the first thickened portion has a large thermal capacity, and effectively absorbs friction heat at the first gear support portion. In addition, unnecessary thickening can be eliminated to form the first thickened portion that has a large thermal capacity, contributing to the weight saving of the differential casing.

Moreover, the drive torque of the ring gear is transmitted to the pinion shaft, and is transmitted to the pinion gear and to the side gear. Hence, the torque is not transmitted or received between the pinion shaft and the shaft hole boss. That is, the differential casing that has the integral shaft hole boss is present outside the transmission route of the drive torque, and is free from the transmission of the drive torque. This enables the thinning and weight saving of the differential casing.

Furthermore, the lubrication oil in the differential casing passes through the gap provided between the pinion shaft and the shaft hole boss, and flow out to the exterior of the differential casing. Hence, lubrication for, in particular, the pinion gear and the first gear support portion near the gap becomes excellent, suppressing heat generation at the first gear support portion and causing heat exhaust to the exterior of the differential casing through the lubrication oil. This also enhances the heat dissipation performance of the differential casing.

### BRIEF DESCRIPTION OF DRAWINGS

FIG. 1 is a vertical cross-sectional view (a cross-sectional view taken along a line 1-1 in FIG. 2) illustrating a differential device according to a first embodiment in a state built in a transmission casing of a vehicle;

FIG. 2 is a diagram as viewed along an arrow 2 in FIG. 1;

FIG. 3 is a diagram as viewed along an arrow 3 in FIG. 1;

FIG. 4 is a diagram as viewed along an arrow 4 in FIG. 3 and illustrating only a differential casing;

FIG. 5 is a cross-sectional view taken along a line 5-5 in FIG. 3 and illustrating only the differential casing;

FIG. 6 is a diagram as viewed along an arrow 6 in FIG. 1 and illustrating only the differential casing; and

FIG. 7 is a perspective view of a pinion shaft.

### DESCRIPTION OF EMBODIMENTS

As embodiments of the present disclosure, a first embodiment will be described below with reference to the accompanying figures.

### First Embodiment

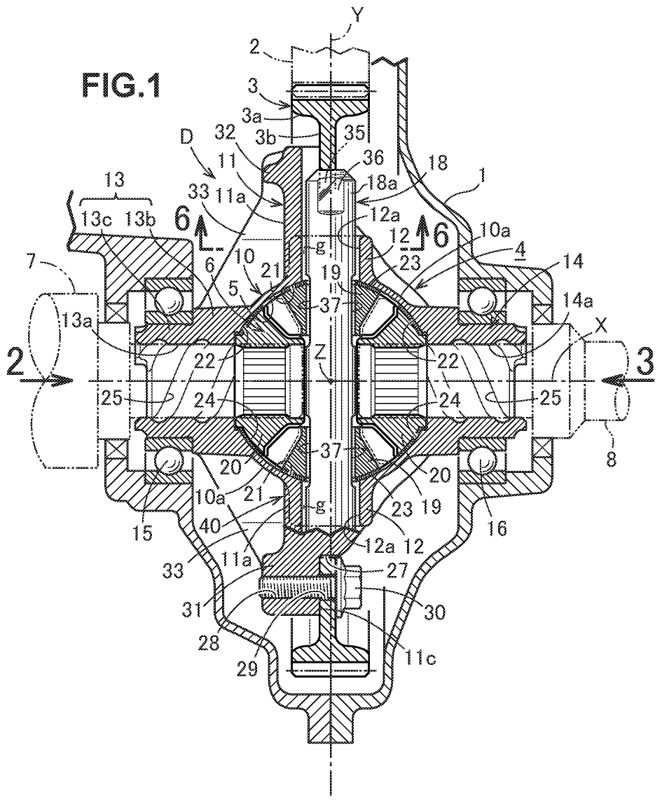

First, as illustrated in FIG. 1 to FIG. 3, a differential device D of the present disclosure is held in a transmission casing 1 of a vehicle. The differential device D mainly includes a ring gear 3 meshed with a drive gear 2 that is the output gear of a transmission, a differential casing 4 that rotates together with the ring gear 3 along a first axial line X, and a differential mechanism 6 which is held in a mechanism space 5 of the differential casing 4, and which distributes and transmits the drive force by the ring gear 3 to first and second drive shafts 7 and 8 arranged side by side on the first axial line X.

The drive gear 2 and the ring gear 3 are each a helical gear. The ring gear 3 includes a rim 3a that has gear teeth formed on the outer circumference, and an annular web 3b that protrudes from the center portion of the inner circumferential surface of the rim 3a in the widthwise direction.

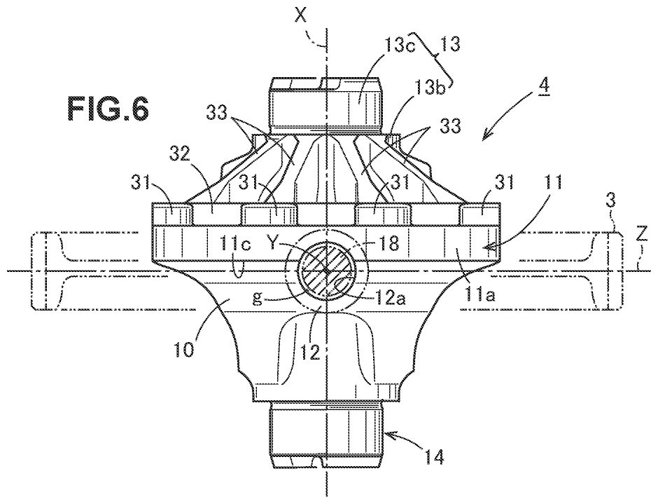

The differential casing 4 is formed of lightweight alloy (e.g., an Al alloy) and integrally formed by casting, such as gravity casting or diecast casting, and includes a differential casing body 10 that has an interior which is the spherical mechanism space 5, a flange 11 which is integrally provided on the outer circumferential portion of the differential casing body 10 to attach the ring gear 3, and which protrudes in the radial direction, a pair of shaft hole bosses 12 (see FIG. 6) provided integrally in the outer circumferential portion of the differential casing body 10 on a second axial line Y that intersects with the first axial line X at right angles and at the center portion of the mechanism space 5, and first and second bearing bosses 13 and 14 which are integrally provided at respective sides of the differential casing body 10 so as to protrude therefrom, and which are arranged on the first axial line X. The first and second bearing bosses 13 and 14 are rotatably supported by the transmission casing 1 through first and second ball bearings 15 and 16, respectively, and support the first and second drive shafts 7 and 8, respectively, so as to be rotatable at respective bearing holes 13a and 14a.

The differential mechanism 6 includes a pinion shaft 18 placed in the mechanism space 5 through shaft holes 12a of the shaft hole bosses 12, a pair of bevel pinion gears 19 that is supported by the pinion shaft 18 so as to be rotatable, and a pair of bevel side gears 20 meshed with the corresponding pinion gears 19. The back surface of the pinion gear 19 and that of the side gear 20 are all formed in a spherical surface so as to correspond to the inner surface of the spherical mechanism space 5, and are rotatably and slidably supported by first and second gear support portions 21 and 22 on the inner surface of the mechanism space 5 through washers 23 and 24, respectively. In the above-described components, the pinion shaft 18, the pinion gears 19, and the side gears 20 are formed of steel.

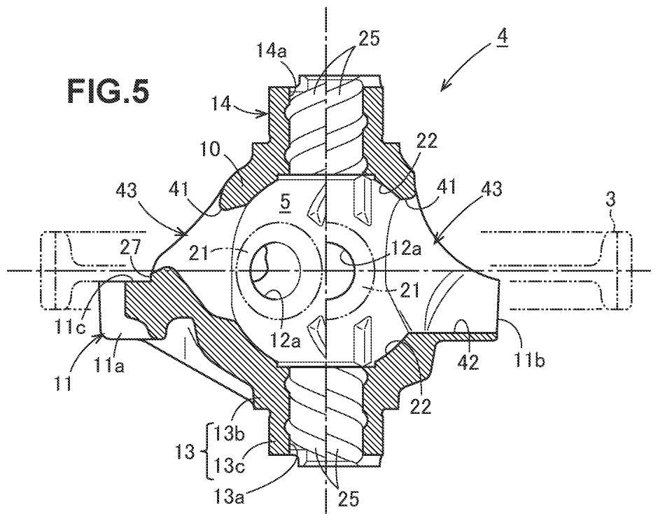

The first gear support portion 21 is designed within an annular region that surrounds the open end of the shaft hole 12a of each shaft hole boss 12 in the inner surface of the mechanism space 5 (see FIG. 5). Moreover, the second gear support portions 22 are designed within an annular region that surrounds the open ends of the bearing holes 13a and 14a of the corresponding first and second bearing bosses 13 and 14 in the inner surface of the mechanism space 5 (similarly, see FIG. 5).

Respective spiral grooves 25 for supplying a lubrication oil in the transmission casing 1 into the mechanism space 5 through the first and second ball bearings 15 and 16 by the forward rotation of the differential casing 4 when the vehicle moves forward are provided in the respective inner circumferential surfaces of the bearing holes 13a and 14a of the first and second bearing bosses 13 and 14.

The flange 11 includes a pair of circular-arc shape flange pieces 11a which extends in the opposite directions to each other along the second axial line Y from the outer circumference surface of the differential casing body 10 and which protrudes outwardly in the radial direction relative to the respective shaft hole bosses 12, and both end surfaces 11b of these flange pieces 11a are each a flat surface in parallel with the second axial line Y.

According to these flange pieces 11a, one side surface at the second-bearing-boss-14 side is a gear attachment surface 11c as a gear attachment portion, and each flange piece 11a is provided with a plurality of screw holes 28 (four in the illustrated example) which is opened in the gear attachment surface 11c along the circumferential direction of the flange 11 at an equal pitch. These screw holes 28 may be a bottomless type screw hole, but may be a screw hole with a bottom. Moreover, a positioning cylindrical surface 27 which extends in the axial direction from the base of the gear attachment surface 11c, and which is coaxial with the first axial line X is formed on the outer circumference of the differential casing body 10.

When the ring gear 3 is attached to the pair of flange pieces 11a, the web 3b overlaps the gear attachment surface 11c with the inner circumferential surface of the web 3b of the ring gear 3 being fitted with the positioning cylindrical surface 27. A plurality of bolt holes 29 to be aligned with the plurality of screw holes 28 of the flange pieces 11a is provided in the web 3b, and by fitting and fastening a plurality of bolts 30 inserted in these bolt holes 29 to the corresponding screw holes 28, the ring gear 3 is attached the pair of flange pieces 11a at the coaxial position to the first axial line X. At this time, the ring gear 3 is placed in such a way that the web 3b is located on the second axial line Y.

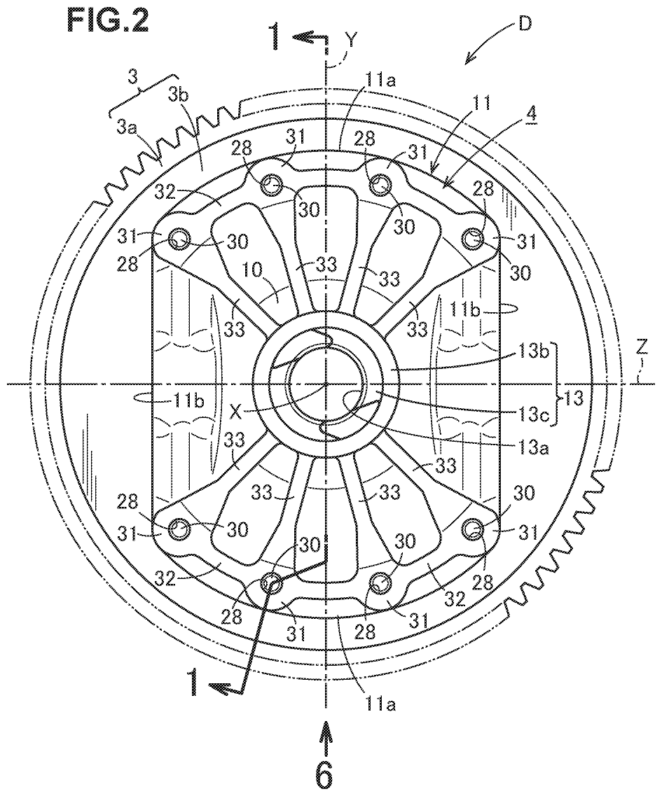

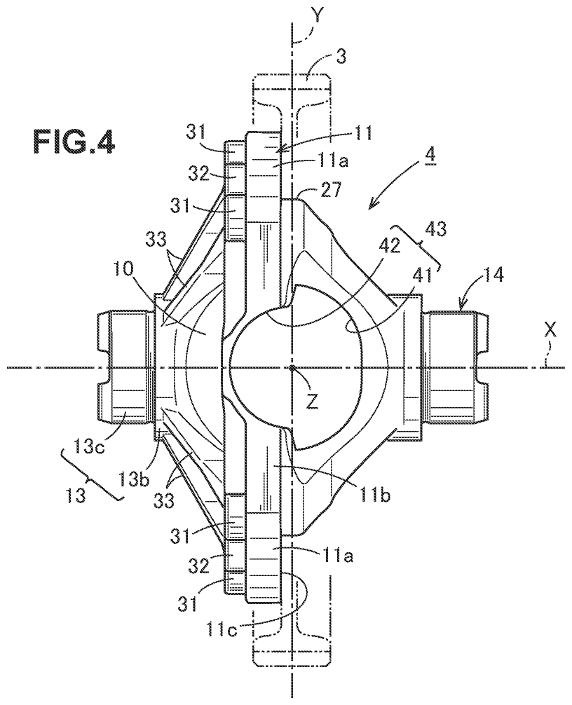

As illustrated in FIG. 1, FIG. 2, FIG. 4, and FIG. 6, formed in the other side surface of each flange piece 11a, i.e., the side face opposite to the gear attachment surface 11c are a plurality of screw hole bosses 31 that protrudes so as to include the corresponding screw hole 28, and first ribs 32 each formed in a circular arc shape, and extending in the circumferential direction of the flange piece 11a so as to integrally join the plurality of screw hole bosses 31 together.

Moreover, a plurality of, in the illustrated example, four second ribs 33 which integrally joins the plurality of screw hole bosses 31 to the first bearing boss 13 through the flange piece 11a and through the differential casing body 10 is formed radially on the side face of the differential casing 4 at the first-rib-32 side. In each flange piece 11a, the four second ribs 33 are arranged symmetrically at each side of the second axial line Y where the shaft hole boss 12 is placed as viewed in the side face of the differential casing 4 (see FIG. 2 and FIG. 6).

Moreover, as illustrated in FIG. 2, each second rib 33 is formed in such a way that a portion toward the external side in the radial direction increases a width as coming close to the joined portion with the first rib, and thus being joined to not only the screw hole boss 31 but also the first rib 32.

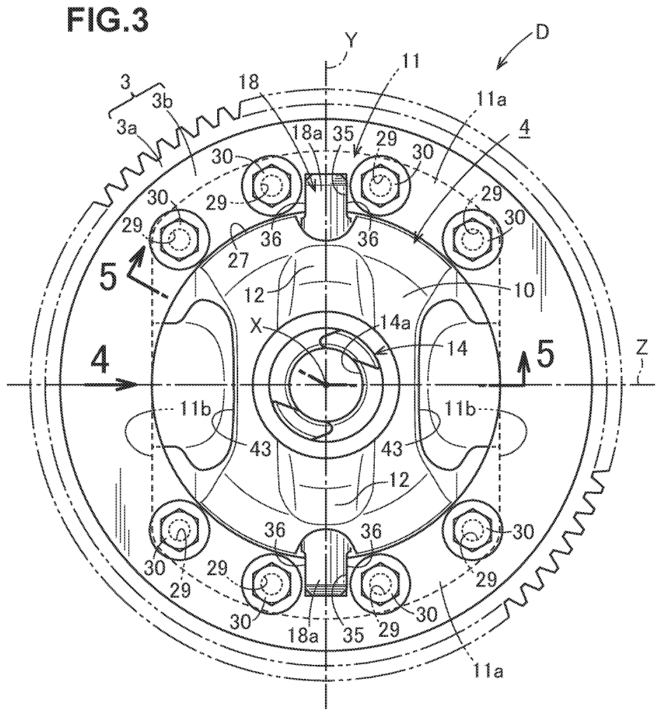

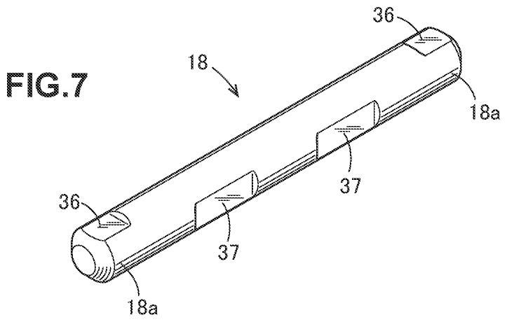

As illustrated in FIG. 1, FIG. 3, and FIG. 7, joint recesses 35 each being a notch are provided in the inner circumferential surface of the web 3b of the ring gear 3, and joint portions 18a in a cut-out circular shape that has a pair of flat surfaces 36 are provided at respective ends of the pinion shaft 18 that protrude outwardly relative to the corresponding shaft hole bosses 12. The joint portion 18a is engaged with the corresponding joint recess 35 in such a way that the flat surface 36 of the joint portion 18a abuts the inner side face of the joint recess 35. In this case, as illustrated in FIG. 1 and FIG. 6, a gap g that avoids abutment is designed between the pinion shaft 18 and the shaft hole 12a of the shaft hole boss 12 that receives the pinion shaft 18.

Moreover, as illustrated in FIG. 1 and FIG. 7, notches 37 for forming respective oil receivers with the inner circumferential surface of the pinion gear 19 are formed in the outer circumference surface of the pinion shaft 18.

As illustrated in FIG. 1 and FIG. 6, the pair of flange pieces 11a are thicker than the pair of shaft hole bosses 12, and are formed integrally with the shaft hole bosses 12 so as to include the respective one side walls of the shaft hole bosses 12 at the second-rib-33 side. The shaft hole bosses 12 and the flange pieces 11a form a first thickened portion 40 that includes the first gear support portion 21. The first thickened portion 40 is thicker than a portion 10a (see FIG. 1) of the circumferential wall of the differential casing body 10 that covers the meshed portion between the pinion gear 19 and the side gear 20.

Conversely, the first bearing boss 13 includes a large-diameter boss portion 13b that protrudes from the one side portion of the differential casing body 10 so as to include the second gear support portion 22, and a small-diameter boss portion 13c that protrudes from the end surface of the large-diameter boss portion 13b, and the second ribs 33 are connected to the large-diameter boss portion 13b. Moreover, the first bearing boss 13 is supported by the transmission casing 1 through a first ball bearing 15 in the small-diameter boss portion 13c.

The large-diameter boss portion 13b that is the base of the first bearing boss 13 becomes a second thickened portion that includes the second gear support portion 22, and is thicker than the portion 10a of the circumferential wall of the differential casing body 10 which covers the meshed portion between the pinion gear 19 and the side gear 20.

Note that the second bearing boss 14 is formed symmetrically to the first bearing boss 13.

As illustrated in FIG. 3 to FIG. 5, a pair of large notched holes 41 each in a semi-elliptic form and arranged along a third axial line Z orthogonal to the first axial line X and the second axial line Y is provided in the circumferential wall of the differential casing body 10, and the longer diameter of the large notched hole 41 is directed in the direction in parallel with the second axial line Y. Moreover, respective small notched holes 42 in a semi-circular shape and in communication with the respective large notched holes 41 are formed in respective flat end surfaces 11b of the respective flange pieces 11a. The radius of the small notched hole 42 is smaller than the shorter diameter of the large notched hole 41. These large notched holes 41 and the small notched holes 42 form respective work windows 43 that form an access to the mechanism space 5 from the exterior.

The small notched hole 42 is mainly utilized for inserting a tool in the mechanism space 5 along the third axial line Z for processing the spherical inner surface of the mechanism space 5, and the work windows 43 are utilized for putting the pinion gears 19, the side gears 20, and the washers 23 and 24 in the mechanism space 5.

Next, actions according to the first embodiment will be described.

When the differential device D is to be assembled, after the pinion gears 19 and the side gears 20, etc., are placed in the mechanism space 5 through the work windows 43, the pinion shaft 18 is fitted in the pair of pinion gears 19 through the shaft hole 12a of the one shaft hole boss 12, and is caused to pass through the shaft hole 12a of the other shaft hole boss 12, thereby causing the joint portions 18a of the pinion shaft 18 at the respective ends to protrude outside the respective shaft hole bosses 12.

Next, the pair of joint recesses 35 of the web 3b is fitted with the corresponding joint portion 18a of the pinion shaft 18 while the web 3b of the ring gear 3 is being engaged with the positioning cylindrical surface 27 of the differential casing 4. That is, the inner side face of the joint recess 35 is caused to abut the flat surface 36 of the joint portion 18a. Next, the web 3b overlaps the gear attachment surface 11c of the pair of flange pieces 11a, and the plurality of bolts 30 inserted in the plurality of bolt holes 29 of the web 3b is fastened to the plurality of screw holes 28 of the flange piece 11a, thereby fastening the ring gear 3 to the flange piece 11a. Hence, by the engagement between the respective joint recesses 35 and the respective joint portions 18a, the ring gear 3 and the pinion shaft 18 are coupled to each other so as to be able to transmit torque, and the movement of the pinion shaft 18 in the axial direction is prevented.

Next, in the assembling line of a vehicle, the transmission casing 1 is caused to support the first and second bearing bosses 13 and 14 of the differential casing 4 through the first and second ball bearings 15 and 16. Subsequently, the first and second drive shafts 7 and 8 inserted in the first and second bearing holes 13a and 14a of the first and second bearing bosses 13 and 14 are coupled to the pair of side gears 20 by spline fitting.

When the drive gear 2 drives the ring gear 3 by drive force from an engine while the vehicle is running, as described above, the drive torque of the ring gear 3 is directly transmitted to the pinion shaft 18 coupled to the ring gear 3 so as to transmit torque, is also transmitted to the pinion gears 19 and the side gears 20, and is further transmitted to the first and second drive shafts 7 and 8, thereby driving those. Hence, torque is not transmitted or received between the pinion shaft 18 and each shaft hole boss 12 through which such a shaft passes. That is, the differential casing body 10 that has the integral shaft hole bosses 12 is located outside the transmission route of the drive torque, and is free from the transmission of the drive torque. This enables the differential casing to be thinned and to reduce the own weight.

The respective flat end surfaces 11b of the pair of flange pieces 11a that forms the flange 11 are located near the mechanism space 5 rather than the outer circumferential surface of the flange piece 11a. Hence, by providing the small notched hole 42 for inserting a tool for processing the inner surface of the mechanism space 5 in each end surface 11b, the overhang amount of the tool from a processing machine can be reduced as much as possible, and the precision of the processing of the inner surface of the mechanism space 5 can be enhanced.

Since the drive gear 2 and the ring gear 3 are each a helical gear, when these transmit torque, a thrust load is produced at the meshed portion between those gears 2 and 3, and a point on which the thrust load acts to the ring gear 3 moves in accordance with the rotation of the ring gear 3.

Moreover, the thrust load is transmitted to the screw hole boss 31 from the bolt 30 near the moving point on which the thrust load acts, is transmitted to the plurality of other screw hole bosses through the first ribs 32, and is also transmitted to the plurality of second ribs 33 and the first bearing boss 13. Hence, the thrust load is supported by these screw hole bosses 31, the first ribs 32, the second ribs 33 and the first bearing boss 13 together.

In particular, by forming each second rib 33 in such a way that a portion toward the external side of the radial direction increases the width as coming close to the joined portion with the first rib, and directly joined to the screw hole boss 31 and the first rib 32, the joining force among the three components that are the screw hole boss 31, the first rib 32 and the second rib 33 is enhanced. This enables the thrust load acting on the screw hole boss 31 to be effectively transmitted to the first rib 32 and the second rib 33.

Hence, although the differential casing 4 is formed of lightweight alloy, since is it effectively reinforced by the screw hole bosses 31, the first ribs 32, the second ribs 33 and the first bearing boss 13, a large rigidity that can withstand the moving thrust load is ensured, and the tilting of the ring gear 3 due to the thrust load is suppressed. Hence, an appropriate meshed state between the drive gear 2 and the ring gear 3 can be maintained.

When, for example, the vehicle is running so as to make a turn, and when the differential mechanism 6 allows a difference in rotation of the first and second drive shafts 7 and 8, the pair of pinion gears 19 rotate in the opposite directions to each other around the pinion shaft 18. This generates rotation and slide frictional heat at the first gear support portion 21 of the inner surface of the mechanism space 5 that rotatably supports the back surfaces of these pinion gears 19.

However, since the first thickened portion 40 that includes the shaft hole boss 12 and the flange piece 11a is formed in the portion of the circumferential wall of the differential casing body 10 including the first gear support portion 21, and the first thickened portion 40 is thicker than the portion 10a of the circumferential wall of the differential casing body 10 that covers the meshed portion between the pinion gear 19 and the side gear 20, and thus having a large thermal capacity. Hence, although the frictional heat generated at the first gear support portion 21 is absorbed by the first thickened portion 40, an excessive temperature rise at the first thickened portion 40 that has a large thermal capacity does not occur. Moreover, the heat absorbed by the first thickened portion 40 is promptly dissipated by heat dissipation function from the plurality of second ribs 33 continuous to the first thickened portion 40 through the differential casing body 10, and the first ribs 32 continuous thereto. In particular, since the first thickened portion 40 includes the shaft hole boss 12 formed in the outer circumferential portion of the differential casing body 10 on the second axial line, and the second ribs 33 are placed at the both sides of the second axial line Y as viewed from the side face of the differential casing 4, at least the two second ribs 33 at both sides of the second axial line Y are placed near the shaft hole boss 12, and effectively receive heat transferred from the first thickened portion 40, thereby accomplishing an excellent heat dissipation function.

Conversely, the large-diameter boss portion 13b of the first bearing boss 13 is formed as the second thickened portion at the portion of the circumferential wall of the differential casing body 10 that includes the second gear support portion 22, the large-diameter boss portion 13b is thicker than the portion 10a of the circumferential wall of the differential casing body 10 which covers the meshed portion between the pinion gear 19 and the side gear 20, and has a large thermal capacity. Hence, the frictional heat generated at the second gear support portion 22 together with the rotation of the side gear 20 is absorbed by the large-diameter boss portion 13b, and is promptly dissipated by the heat dissipation fin function from all the second ribs 33 joined to the large-diameter boss portion 13b, and the first ribs 32 continuous thereto.

As described above, the differential casing 4 formed of lightweight alloy accomplishes the excellent heat dissipation performance, and thus the expansion of the differential casing 4 due to heat generation accompanying with the actuation of the differential mechanism 6 can be suppressed.

Note that at the portion 10a of the circumferential wall of the differential casing body 10 which covers the meshed portion between the pinion gear 19 and the side gear 20, since a sliding friction with the meshed portion does not occur, it is unnecessary to increase the thermal capacity unlike the first thickened portion 40 and the second thickened portion (the large-diameter boss portion 13b). Hence, the thickness thereof can be positively reduced, contributing to the weight saving of the differential casing 4.

Moreover, the lubrication oil retained at the bottom of the transmission casing 1 while the vehicle is running passes through the first and second ball bearings 15 and 16 which support the first and second bearing bosses 13 and 14, respectively, and is transferred into the mechanism space 5 through the spiral grooves 25 in the respective inner circumferential surfaces of the bearing holes 13a and 14a, lubricates each component of the differential mechanism 6, passes through the work windows 43 due to the centrifugal force by the rotation of the differential casing 4 and through the gap g between the pinion shaft 18 and the shaft hole boss 12, and is returned to the exterior of the differential casing body 10, i.e., inside the transmission casing 1. This circulation is to be repeated.

During such a circulation, in particular, at the sliding portion between the pinion gear 19 and the first gear support portion 21 near the gap g, an excellent lubrication is accomplished by the lubrication oil travelling to the gap g, the heat generation due to the sliding friction is suppressed, and exhaust heat to the exterior of the differential casing body 10 is caused through the lubrication oil. Hence, this also enhances the heat dissipation performance of the differential casing 4.

As described above, since the second bearing boss 14 is formed so as to be symmetrical to the first bearing boss 13, the large-diameter boss portion thereof also serves as the second thickened portion that includes the second gear support portion 22 like the large-diameter boss portion 13b of the first bearing boss 13. A thickened circumferential edge portion (see FIG. 5) of the work window 43 of the differential casing body 10 is continuous to the large-diameter boss portion of the second bearing boss 14, thus increasing the thermal capacity around the large-diameter boss portion. Hence, frictional heat generated at the second gear support portion 22 at the second-bearing-boss 14 side is absorbed by the large-diameter boss portion of the second bearing boss 14 and the thickened circumferential edge portion, and heat is exhaust by the lubrication oil flowing out from the work window 43. This also enhances the heat dissipation performance of the differential casing 4.

Moreover, by forming the recess in the outer surface of the differential casing body 10 for thinning of the portion 10a of the circumferential wall of the differential casing body 10 which covers the meshed portion between the pinion gear 19 and the side gear 20, the surface area of the differential casing body 10 can be increased, which is advantageous for enhancing the heat dissipation performance. In addition, since the differential casing 4 is formed of lightweight alloy that has a higher thermal conductivity than that of steel, the heat dissipation is prompted.

The present disclosure is not limited to the above-described first embodiment, and various design changes within the scope of the present disclosure can be made.

For example, according to the first embodiment, although the first and second drive shafts 7 and 8 that are coupled to the pair of the side gears 20 are directly supported by the bearing holes 13a and 14a of the first and second bearing bosses 13 and 14, respectively, those may be supported by the bearing holes 13a and 14a through a sleeve which is integrally formed with or joined to the hub of the side gear 20 (see JP 2015-145702 A). Moreover, the flange 11 may be formed in a singular circular disk shape instead of the pair of flange pieces 11a. Furthermore, the differential casing 4 may be a split structure that is split by a split plane including, for example, the second axial line Y. Moreover, the differential casing 4 may be formed by forging, machining, etc., in addition to casting.

### REFERENCE SIGNS LIST

D Differential device
X First axial line
Y Second axial line
g Gap
1 Transmission casing
2 Drive gear
3 Ring gear
4 Differential casing
5 Mechanism space
6 Differential mechanism
7 First drive shaft
8 Second drive shaft
10 Differential casing body
10a Portion of differential casing body that covers meshed portion between pinion gear and side gear
11 Flange
11a Flange piece
11c Gear attachment portion (gear attachment surface)
12 Shaft hole boss
12a Shaft hole
13 First bearing boss
13b Large-diameter boss portion (second thickened portion)
13c Small-diameter boss portion
14 Second bearing boss
18 Pinion shaft
19 Pinion gear
20 Side gear
21 First gear support portion
22 Second gear support portion
28 Screw hole
29 Bolt hole
30 Bolt
31 Screw hole boss
32 First rib
32 Second rib
40 First thickened portion

1. A differential device comprising:
a ring gear that is meshed with and driven by a drive gear coupled to an engine;
a differential casing which is formed of lightweight alloy and which rotates together with the ring gear around a first axial line; and
a differential mechanism which is held in a mechanism space of the differential casing, and which includes gears for distributing and transferring drive force by the ring gear to first and second drive shafts arranged side by side along the first axial line, the gears being formed of steel,
wherein the differential mechanism comprises:
a pinion shaft placed on a second axial line intersecting with the first axial line in the mechanism space at right angles;
a pinion gear which is rotatably supported by the pinion shaft, and which has a back surface supported by a first gear support portion of an inner surface of the mechanism space; and
a side gear which is coupled to the first and second drive shafts while being meshed with the pinion gear, and which has a back surface supported by a second gear support portion of an inner surface of the mechanism space,
wherein the differential casing comprises:
a differential casing body that defines the mechanism space;
a flange which is integrally provided with an outer circumferential portion of the differential casing body, and which includes, at one side surface, a gear attachment portion to which the ring gear is fastened by a plurality of bolts arranged side by side in a circumferential direction; and
first and second bearing bosses which are integrally provided at respective sides of the differential casing body, arranged with a transmission casing side by side on the first axial line so as to be rotatably supported, and rotatably support the first and second drive shafts,
wherein a plurality of protruding screw hole bosses each having a screw hole to be fastened with each of the plurality of bolts, and a first rib that integrally joints the plurality of screw hole bosses together are formed in and on an other side face of the flange,
wherein a plurality of second ribs each joining each of the screw hole bosses and the first bearing boss at the other-side-face side together through the flange and through the differential casing body is formed on an external side face of the differential casing,
wherein a first thickened portion which includes the first gear rotatably support portion and which is thicker than a portion of a circumferential wall of the differential casing that covers a meshed portion between the pinion gear and the side gear is formed on the circumferential wall, and
wherein a second thickened portion which includes the second gear support portion and which is thicker than the portion of the circumferential wall that covers the meshed portion between the pinion gear and the side gear is formed on the first bearing boss.

2. The differential device according to claim 2, wherein:
the first thickened portion comprises a shaft hole boss which is formed in the outer circumferential portion of the differential casing body on the second axial line, and which receives an end of the pinion shaft; and
the second ribs are placed at both sides of the second axial line as viewed from a side face of the differential casing.

3. The differential device according to claim 1, wherein:
the first thickened portion is formed by the shaft hole boss, and the flange that is integrally formed with the shaft hole boss so as to include a side wall of the shaft hole boss at a second-rib side; and
the ring gear and the pinion shat are coupled to each other so as to transmit torque, and a gap is provided between a shaft hole of the shaft hole boss and the pinion shaft received therein.

4. The differential device according to claim 2, wherein:
the first thickened portion is formed by the shaft hole boss, and the flange that is integrally formed with the shaft hole boss so as to include a side wall of the shaft hole boss at a second-rib side; and
the ring gear and the pinion shat are coupled to each other so as to transmit torque, and a gap is provided between a shaft hole of the shaft hole boss and the pinion shaft received therein.
